(19) United States
(12) Patent Application Publication
(10) Pub. No.: US 2009/0021711 A1
(43) Pub. Date: Jan. 22, 2009

(54) METHOD OF INSPECTING EXPOSURE SYSTEM AND EXPOSURE SYSTEM

(76) Inventors: Takashi Sato, Fujisawa-shi (JP); Soichi Inoue, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/173,943

(22) Filed: Jul. 16, 2008

(30) Foreign Application Priority Data
Jul. 17, 2007 (JP) 2007-186154

(51) Int. Cl. G03B 27/42; G01B 11/14

(52) U.S. Cl. 355/53; 356/615

(57) ABSTRACT

A method of inspecting an exposure system uses a mask pattern including a first and a second mask pattern, the first pattern being formed in a line-and-space of a first pitch, the second pattern being disposed in parallel with the first mask pattern and formed in a line-and-space of a second pitch. The method includes illuminating the mask pattern with inspection light at a first angle with the optical axis of the illumination light from a light source, allowing the first mask pattern to diffract the inspection light to generate first diffraction light, and allowing the second mask pattern to diffract the inspection light to generate second diffraction light. The first angle is to allow the first diffraction light to be diffracted asymmetrically with the optical axis into the projection optical system and the second diffraction light to be diffracted symmetrically with the optical axis into the projection optical system.

### CROSS-REFERENCE TO RELATED APPLICATIONS

This application is based upon and claims the benefit of priority from the prior Japanese Patent Application No. 2007-186154, filed on Jul. 17, 2007, the entire contents of which are incorporated herein by reference.

### BACKGROUND OF THE INVENTION

1. Field of the Invention

The present invention relates to a method of inspecting an exposure system for use in a semiconductor lithography process and an exposure system.

2. Description of the Related Art

The semiconductor manufacturing process includes a light lithography process. The lithography process uses a projection exposure system (stepper) to form a fine resist pattern. The condition of the optical system in the exposure system, particularly the focal point (focus position) of the exposure system needs to be set appropriately. If the focal point of the exposure system is set inappropriately, a defocus easily occurs. This inhibits the formation of the desired fine pattern. Particularly, recent transfer patterns have increasingly become smaller, which makes it very important to accurately set the focal point of the exposure system.

Various technologies have therefore been developed to accurately set the focal point. Such technologies include accurate monitoring of the focal point of the exposure system using the transfer pattern during the exposure.

The technologies also include a monitoring technology using a phase shift pattern. The monitoring technology using a phase shift pattern is exemplified in “Gune E. Fuller, Optical Microlithography IX, PROCEEDINGS SPIE—The International Society for Optical Engineering, 13-15 March 1996 Santa Clare, Calif.” (non-patent document 1).

The method in the non-patent document 1 uses a predetermined original mask. The original mask has a first to a third layer formed at regular intervals. The first layer transmits light. The second layer blocks light. The third layer (phase shifter) changes the light phase by 90° relative to the first layer. The original mask thus formed is used to transfer the mask pattern onto the semiconductor substrate. If the semiconductor substrate position (the focal point of the exposure system) is shifted from the best position, the pattern transferred from the original mask onto the semiconductor substrate will have a certain position shift from the reference pattern, accordingly. The position shift is generally proportional to the shift from the best focus position. The method in the non-patent document 1 reads the position shift using a misalignment inspection device or the like, and uses the results to accurately monitor the focus position of the exposure system.

Unfortunately, the method in the non-patent document 1 uses a specially configured original mask. This results in high cost of the phase shifter manufacturing.

A focus monitoring method that can be performed at lower cost than the method in the non-patent document 1 is disclosed in Shuji Nakao, Yuki Miyamoto, Naohisa Tamada, Shigenori Yamashita, Akira Tokui, Koichiro Tsuchida, Ichiro Arimoto, Wataru Wakamiya, “Discussion on Focus Monitoring with Decentered Illumination,” 2001 Spring Japan Society of Applied Physics Annual Meeting Abstract, No. 2, p. 733 (2001) (non-patent document 2). The method in the non-patent document 2 uses an aperture of a predetermined shape and performs double exposure of the decentered illumination and the normal illumination.

Unfortunately, the method in the non-patent document 2 should perform the double exposure to transfer the inspection pattern (measurement pattern). The exposure thus needs more time to complete. When, therefore, the focus monitoring method is applied to the mass production, the productivity is reduced. To accurately measure the focus position, the position shift of the measurement pattern should be read with accuracy within a few nanometers. The double exposure should thus be performed with the mask and the transfer substrate being strictly fixed during the first and second exposures. Additionally, the exposure is complicated.

### SUMMARY OF THE INVENTION

An aspect of the present invention is a method of inspecting an exposure system, the exposure system using a mask pattern including a first mask pattern and a second mask pattern, the first mask pattern being formed in a stripe having a line-and-space of a first pitch, the second mask pattern being disposed in parallel with the first mask pattern and formed in a stripe having a line-and-space of a second pitch different from the first pitch, the exposure system including a projection optical system for projecting illumination light to a substrate from a light source, the method including: illuminating the mask pattern with inspection light at a first angle with the optical axis of the illumination light, allowing the first mask pattern to diffract the inspection light to generate first diffraction light, and allowing the second mask pattern to diffract the inspection light to generate second diffraction light; measuring the relative distance between a first image due to the first mask pattern and a second image due to the second mask pattern, the first and second images being projected on the substrate via the projection optical system; and inspecting the condition of the projection optical system based on the relative distance, the first angle being set to allow the first diffraction light to be diffracted asymmetrically with respect to the optical axis into the projection optical system and the second diffraction light to be diffracted symmetrically with respect to the optical axis into the projection optical system.

An aspect of the present invention is an exposure system including: a mask stage for supporting a mask pattern including a first mask pattern and a second mask pattern, the first mask pattern being formed in a stripe having a line-and-space of a first pitch, the second mask pattern being disposed in parallel with the first mask pattern and formed in a stripe having a line-and-space of a second pitch different from the first pitch; a light source for illuminating the mask stage with illumination light used for exposure of a substrate; an inspection light illumination portion for illuminating the mask pattern with inspection light at a first angle with the optical axis of the illumination light; and a projection optical system for projecting the illumination light to the substrate, the first angle being set to allow the first diffraction light diffracted by the first mask pattern to be diffracted asymmetrically with respect to the optical axis into the projection optical system and the second diffraction light diffracted by the second mask pattern to be diffracted symmetrically with respect to the optical axis into the projection optical system.

### BRIEF DESCRIPTION OF THE DRAWINGS

FIG. 1 schematically illustrates the configuration of an exposure system 10 according to a first embodiment of the present invention;

FIG. 2 illustrates an inspection mask 20 of the exposure system 10 according to the first embodiment of the present invention;

FIG. 3 schematically illustrates a first focus pattern Pa due to the inspection mask 20 in the exposure system 10 according to the first embodiment of the present invention;

FIG. 4 schematically illustrates a second focus pattern Pb due to the inspection mask 20 in the exposure system 10 according to the first embodiment of the present invention;

FIG. 5 illustrates focus patterns P1 to P4 imaged on a wafer W via an inspection mask 20a in the exposure system 10 according to the first embodiment of the present invention;

FIG. 6 shows simulation results of a focus distance shift δf and an imaging position shift δx for the exposure system 10 according to the first embodiment of the present invention;

FIG. 7 shows a flowchart of an inspection method of the exposure system 10 according to the first embodiment of the present invention; and

FIG. 8 schematically illustrates the configuration of an exposure system 10a according to a second embodiment of the present invention.

### DETAILED DESCRIPTION OF THE EMBODIMENTS

With reference to the appended drawings, embodiments of a method of inspecting an exposure system and an exposure system of the present invention will now be described.

### First Embodiment

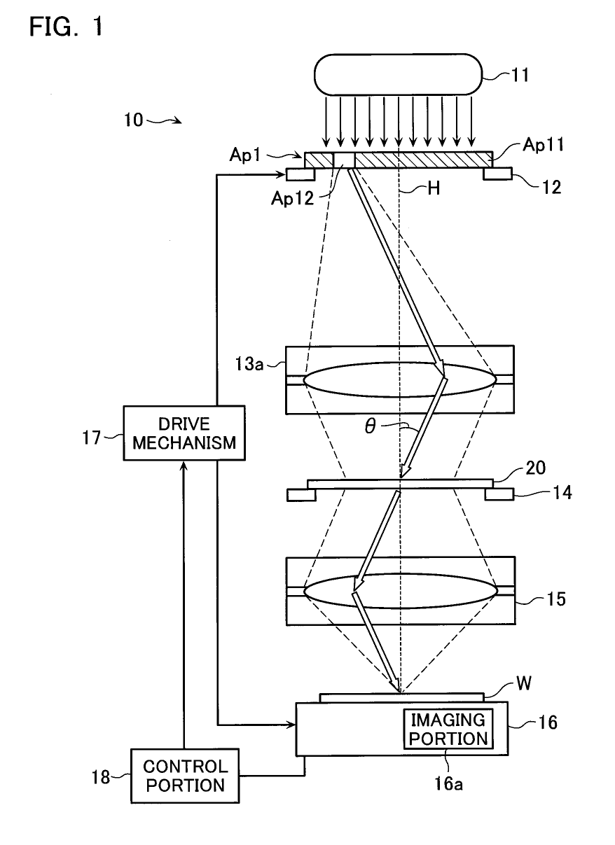

First, with reference to FIG. 1, an exposure system 10 according to a first embodiment of the present invention is described below. FIG. 1 schematically illustrates the exposure system 10 according to the first embodiment of the present invention. With reference to FIG. 1, the exposure system 10 in the first embodiment mainly includes an exposure light source 11, an aperture stage 12, an illumination optical system 13, a photomask stage 14, a projection optical system 15, a wafer stage 16, a drive mechanism 17, and a control portion 18.

The exposure light source 11 is used for exposure of a wafer W in the semiconductor lithography process. The exposure light source 11 irradiates the photomask stage 14 with vertically incident light (“illumination light”). Illumination light from the exposure light source 11 has an optical axis H. Illumination light passes through the aperture stage 12, the illumination optical system 13, the photomask stage 14, and the projection optical system 15 to the wafer stage 16.

The aperture stage 12 resides between the exposure light source 11 and the illumination optical system 13. The stage 12 is adapted to be able to support an aperture Ap1. The aperture Ap1 includes a light shield portion Ap11 and a light transmission hole Ap12. The light shield portion Ap11 shields illumination light from the exposure light source 11. The hole Ap12 is formed through the light shield portion Ap11. The hole Ap12 may transmit illumination light. The light transmission hole Ap12 is provided on the aperture Ap1 to have a predetermined position shift from the optical axis H when the aperture Ap1 is mounted on the aperture stage 12. Illumination light passing through the light transmission hole Ap12 on the aperture Ap1 provides inspection light at a predetermined angle θ with the optical axis H. Inspection light passes through the illumination optical system 13, the photomask stage 14, and the projection optical system 15 to the wafer stage 16. Note that chief ray of inspection light is indicated by hollow arrows in FIG. 1.

The photomask stage 14 is adapted to be able to support a photomask having an exposure pattern for exposure of the wafer W and a photomask having an inspection pattern for inspection of the conditions of the illumination optical system 13 and the projection optical system 15. The photomask stage 14 may also support a photomask having both the exposure pattern and the inspection pattern. A photomask having the inspection pattern is referred to as an inspection mask 20 below.

The wafer stage 16 is adapted to be able to support the wafer W. The wafer stage 16 includes an imaging portion (such as a CCD camera) 16a. The imaging portion 16a captures a focus pattern (image) formed on the wafer W. The drive mechanism 17 is adapted to move the wafer stage 16 toward and away from the exposure light source 11. The drive mechanism 17 is also adapted to be able to move the aperture stage 12 away from the optical axis H. The control portion 18 is adapted to use the focus pattern captured by the imaging portion 16a to compute a defocus of the projection optical system 15. The control portion 18 is adapted to use the focus pattern due to the inspection photomask 20 to control the drive by the drive mechanism 17.

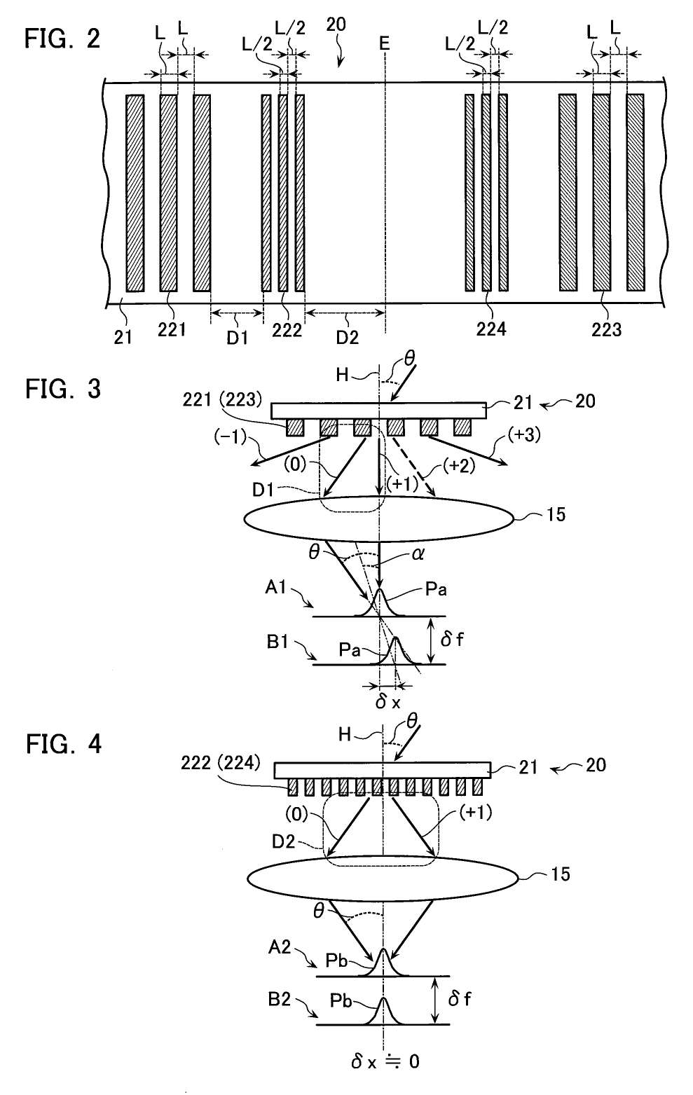

With reference to FIG. 2, the configuration of the inspection mask 20 is described below. FIG. 2 schematically illustrates the mask 20. With reference to FIG. 2, the inspection mask 20 includes a transmissive substrate 21 and a light shield portion 22. The transmissive substrate 21 transmits light beams (of illumination light and inspection light). The light shield portion 22 is formed on a surface of the transmissive substrate 21. The inspection mask 20 is, for example, a binary intensity mask (BIM). The transmissive substrate 21 includes a glass substrate. The light shield portion 22 includes a chromium film.

The light shield portion 22 includes a first pattern 221 and a second pattern 222. The first pattern 221 is formed in a stripe having a line-and-space of a predetermined pitch L. The second pattern 222 is formed at a predetermined distance D1 apart from the first pattern 221 in the pitch direction. The pattern 222 is formed in a stripe having a line-and-space of a predetermined pitch L/2. In other words, the first pattern 221 has a pitch twice that of the second pattern 222. For example, for NA of 0.92, lambda of 193 nm, and sigma of 0.8, the optimum pitch of the first pattern 221 is 131.1 nm and the optimum pitch of the second pattern 222 is 65.5 nm.

The light shield portion 22 further includes a third pattern 223. The third pattern 223 is mirror symmetric to the first pattern 221 with respect to a boundary E. The boundary E resides on the side of the second pattern 222 opposite the first pattern 221 in the pitch direction. The boundary E is a predetermined distance D2 away from the second pattern 222. The light shield portion 22 also includes a fourth pattern 224. The fourth pattern 224 is mirror symmetric to the second pattern 222 with respect to the straight-line boundary E. Note that the first to fourth patterns 221 to 224 are in parallel.

The first and third patterns 221 and 223 are formed in a line-and-space of a predetermined pitch L. The first and third patterns 221 and 223 on the photomask stage 14 diffract inspection light from the aperture Ap1, thus generating first diffraction light. The predetermined angle θ with the optical axis H is an angle that allows the first diffraction light to be diffracted asymmetrically with respect to the optical axis H into the projection optical system 15. The predetermined angle θ is also an angle that provides +1st-order diffraction light in a direction parallel with the optical axis H. The predetermined angle θ is also an angle that allows 0th- and +1st-order diffraction light to pass through the entrance pupil of the projection optical system 15 and does not allow 3rd- or more, −1st-, and −3rd- or less order diffraction light to pass through the entrance pupil of the projection optical system 15. The aperture Ap1 is thus adapted to generate inspection light at the predetermined angle θ with the optical axis H. Note that the first and third patterns 221 and 223 are each formed in a line-and-space of the predetermined pitch L, thus generating no ±2nd-order diffraction light.

As described above, the second and fourth patterns 222 and 224 are each formed in a line-and-space of the pitch L/2, the pitch being half that of the first and third patterns 221 and 223. The second and fourth patterns 222 and 224 on the photomask stage 14 diffract inspection light from the aperture Ap1, thus generating second diffraction light. The predetermined angle θ with the optical axis H is an angle that allows the second diffraction light to be diffracted symmetrically with respect to the optical axis H into the projection optical system 15. The predetermined angle θ is also an angle that allows 0th- and +1st-order diffraction light to pass through the entrance pupil of the projection optical system 15 and does not allow 3rd- or more, −1st-, and −3rd- or less order diffraction light to pass through the entrance pupil of the projection optical system 15. The aperture Ap1 is thus adapted to generate inspection light at the predetermined angle θ with the optical axis H. Note that the second and forth patterns 222 and 224 are each formed in a line-and-space of the predetermined pitch L/2, thus generating no ±2nd-order diffraction light.

With reference to FIGS. 3 to 5, a focus pattern due to the inspection mask 20 is schematically described. FIG. 3 schematically illustrates a focus pattern due to the first pattern 221 or the third pattern 223. FIG. 4 schematically illustrates a focus pattern due to the second pattern 222 or the fourth pattern 224. With reference to FIGS. 3 and 4, the inspection mask 20 is irradiated with inspection light from the aperture Ap1. Inspection light is obliquely incident on the mask 20.

First, with reference to FIG. 3, a focus pattern due to the first pattern 221 or the third pattern 223 is described below. With reference to FIG. 3, inspection light is diffracted by the first or third pattern 221 or 223 on the inspection mask 20, providing first diffraction light D1. The light D1 is diffracted asymmetrically with respect to the optical axis H and is incident on the projection optical system 15. The first diffraction light D1 includes two light beams of the 0th-order diffraction light and the +1st-order diffraction light. The 0th-order diffraction light passes at the predetermined angle θ with the optical axis H and enters the projection optical system 15. The +1st-order diffraction light passes in parallel with the optical axis H and enters the optical system 15. The first diffraction light D1 passes through the projection optical system 15 and forms a first focus pattern (a first image) Pa on the wafer W.

As described above, the first focus pattern Pa is thus due to the first or third pattern 221 or 223. The first or third pattern 221 or 223 provides the first diffraction light D1, which spreads asymmetrically with respect to the optical axis H. The focus pattern Pa is formed at a predetermined position on the wafer W depending on the distance (focus distance) between the inspection mask 20 and the wafer W. With reference to FIG. 3, for example, when moving from the focus distance for the condition A1 (focal point (best focus position)) to the focus distance for the condition B1 (defocus position) by a distance δf, the imaging position of the first focus pattern Pa on the wafer W shifts by δx.

A description is given of the relationship between the shift δx of the imaging position of the first focus pattern Pa on the wafer W due to the first or third pattern 221 or 223 and the shift 5f of the focus distance. It is assumed that when the wafer W is moved away from the condition A1 to the condition B1, the imaging position of the first focus pattern Pa moves in a direction at a moving angle α with the optical axis H. Then, the relationship between the incident angle θ and the moving angle α is represented by the following expression (1)

α=θ/2 (1)

The relationship between the shift δf of the focus distance and the shift δx of the imaging position is represented by the following expression (2). Thus, the shift δf of the focus distance is proportional to the shift δx of the imaging position. The shift δx of the imaging position may then be measured to compute the shift δf of the focus distance.

δx=δf tan(α)=δf tan(θ/2) (2)

With reference to FIG. 4, a focus pattern due to the second pattern 222 or the fourth pattern 224 is described below. With reference to FIG. 4, inspection light is diffracted by the second or fourth pattern 222 or 224 on the inspection mask 20, providing second diffraction light D2. The light D2 is diffracted symmetrically with respect to the optical axis H and is incident on the projection optical system 15. The second diffraction light D2 includes two light beams of the 0th-order diffraction light and the +1st-order diffraction light. The 0th-order diffraction light passes at the predetermined angle θ with the optical axis H and enters the projection optical system 15. The +1st-order diffraction light passes at a predetermined angle −θ with the optical axis H and enters the optical system 15. The second diffraction light D2 passes through the projection optical system 15 and forms a second focus pattern (a second image) Pb on the wafer W.

The second focus pattern Pb is thus due to the second or fourth pattern 222 or 224. The second or fourth pattern 222 or 224 provides the second diffraction light D2, which spreads symmetrically with respect to the optical axis H. The focus pattern Pb is formed at substantially the same position on the wafer W without depending on the focus distance change 5f. With reference to FIG. 4, for example, even when moving from the focus distance for the condition A2 (focal point (best focus position)) to the focus distance for the condition B2 (defocus position) by a distance 5f, the imaging position of the second focus pattern Pb is substantially the same on the wafer W (i.e., δx˜0).

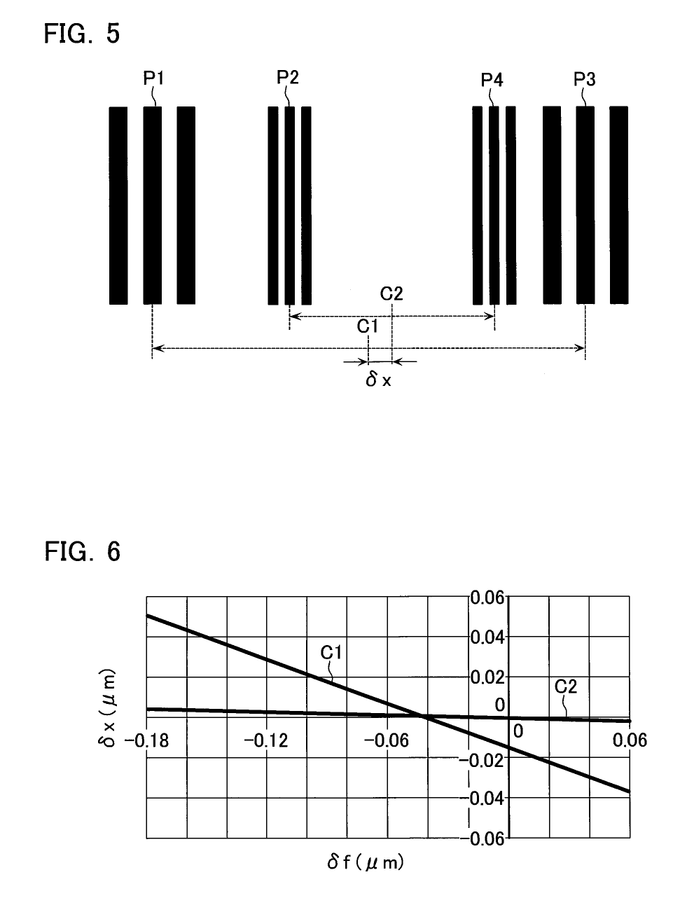

FIG. 5 shows focus patterns P1 to P4 formed on the wafer W due to inspection light obliquely incident on the inspection mask 20 as shown in FIGS. 3 and 4. The focus patterns P1 to P4 are formed by imaging the first to fourth patterns 221 to 224, respectively. The focus patterns P1 and P3 correspond to the first focus pattern (the first image) Pa in FIG. 3. The focus patterns P2 and P4 correspond to the second focus pattern (the second image) Pb in FIG. 4. When, therefore, the center between the focus patterns P1 and P3 is C1 and the center between the focus patterns P2 and P4 is C2, the relative distance between the centers C1 and C2 corresponds to the shift δx of the imaging position. The focus patterns P1 to P4 due to the inspection mask 20 may thus be used to measure the shift δx of the imaging position and compute the shift δf of the focus distance.

FIG. 6 shows the simulated relationship between the shift δx of the imaging position and the shift δf the focus distance in the focus pattern P1 due to the first pattern 221 and the focus pattern P2 due to the second pattern 222. Note that the simulation is done for NA of 0.92, lambda of 193 nm, sigma of 0.8, the first pattern 221 pitch of 131 nm, and the second pattern 222 pitch of 65 nm. With reference to FIG. 6, in the focus pattern P1, the shift δx of the imaging position is directly proportional to the shift δf of the focus distance. In the focus pattern P2, the shift δx of the imaging position is unproportional to the shift δf of the focus distance and is generally constant.

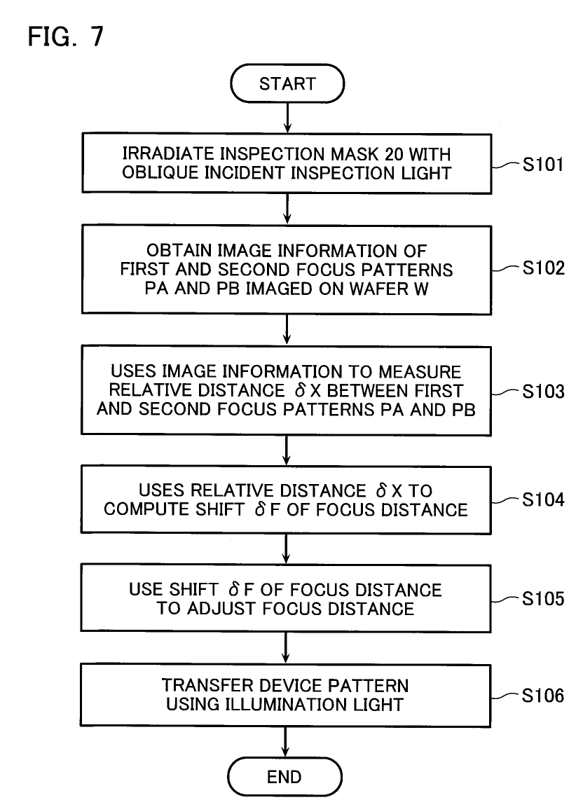

With reference to FIG. 7, an inspection method of the exposure system 10 in the first embodiment is described below. FIG. 7 shows a flowchart of the inspection method of the exposure system 10 in the first embodiment.

With reference to FIG. 7, first, the control portion 18 allows the aperture Ap1 to irradiate the inspection mask 20 with oblique incident inspection light (step S101). The control portion 18 then allows the imaging portion 16a to obtain the image information of the first and second focus patterns Pa and Pb projected on the wafer W (step S102). The imaging portion 16a captures the optical images formed on the surface of the wafer W. Alternatively, a photosensitive material such as resist may be applied in advance on the wafer W, and at step S102, the imaging portion 16a may capture a pattern shape made of the photosensitive material that is exposed (and developed). Also, according to the pattern shape, the wafer W or a film deposited on the wafer W is processed. The imaging portion 16a images the processed shape.

After step S102, as described in FIGS. 3 to 5, the control portion 18 uses the obtained image information to measure the relative distance (imaging position shift) δx between the first and second focus patterns Pa and Pb on the wafer W due to the first to fourth patterns 221 to 224 (step S103). The control portion 18 then uses the relative distance δ to compute the shift 5f of the focus distance (step S104). In other words, at step S104, the control portion 18 computes the shift 5f of the focus distance and thus inspects the optical system condition.

After step S104, the control portion 18 allows the drive mechanism 17 to move the wafer stage 16 toward and away from the inspection mask 20 to adjust the focus (step S105). The control portion 18 then allows the drive mechanism 17 to move the aperture stage 12 to bring the aperture Ap1 away from the optical axis H. The device pattern is then transferred to the wafer W (step S106).

The inspection method of the exposure system in the first embodiment thus inspects the exposure system by using the inspection mask 20 and irradiating the mask 20 with oblique incident inspection light from the aperture 12. The inspection mask 20 may be the BIM and not include a phase shifter formed therein. The mask 20 may thus be manufactured at low cost. The inspection method of the exposure system in the first embodiment does not need a double exposure of the inspection mask 20. In other words, the exposure system and the inspection method in the first embodiment need no special mask or complicated exposure. The optical system condition in the exposure system may thus be measured at low cost, rapidly, with high accuracy, and easily.

According to the first embodiment, the pitch shift of the pattern imaged on the wafer W may be measured to obtain measurement data on the positions in the pupil plane of the projection optical system 15 at which the diffraction light passes through. The measurement data may be used to measure aberrations such as a spherical aberration and a coma aberration.

### Second Embodiment

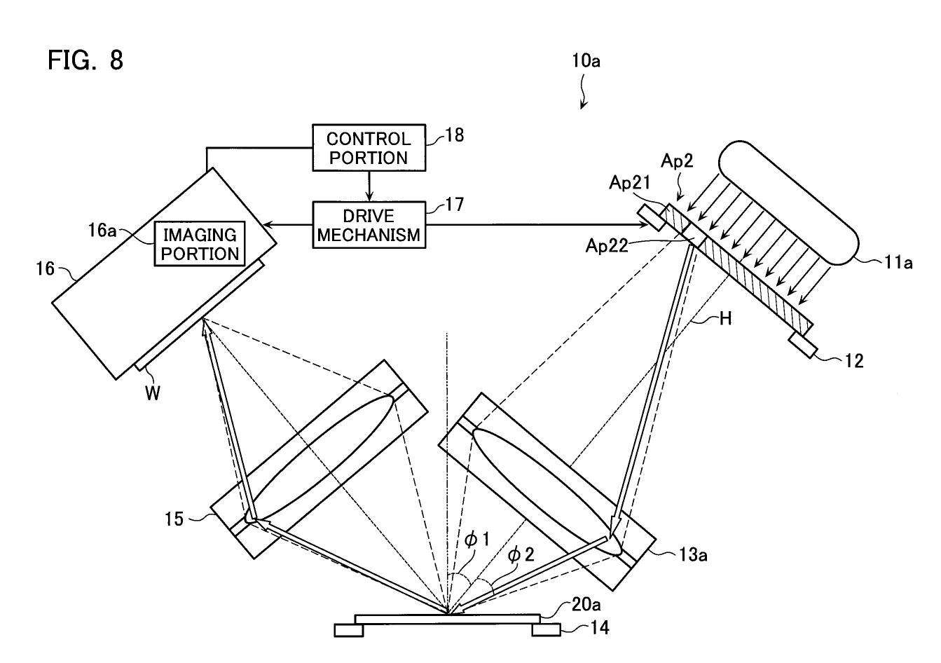

With reference to FIG. 8, an exposure system 10a according to a second embodiment of the present invention is described. FIG. 8 schematically illustrates the exposure system 10a according to the second embodiment of the present invention. With reference to FIG. 8, the exposure system 10a in the second embodiment includes an exposure light source 11a and a reflective inspection mask 20a. The light source 11a emits EUV light (with a wavelength of 13.5 nm) as illumination light. The mask 20a reflects illumination light and inspection light from the exposure light source 11a. Unlike the exposure system 10 in the first embodiment, the exposure system 10a mainly includes the exposure light source 11a, an aperture Ap2, an inspection mask 20a, and other components corresponding to the source 11a, the aperture Ap2, and the mask 20a (the components include the aperture stage 12, the illumination optical system 13a, the projection optical system 15, and the wafer stage 16). In other words, the first embodiment includes the transmissive exposure system 10, while the second embodiment includes the reflective exposure system 10a. Note that in the second embodiment, like elements as those in the first embodiment are designated with like reference numerals and their description is omitted.

The exposure mask 20a includes the first and second patterns as in the first embodiment. For example, for NA of 0.25, lamda of 13.5 nm, sigma of 0.6, and illNA of 0.15, the optimum pitch of the first pattern is 45.0 nm and the optimum pitch of the second pattern is 22.5 nm.

The exposure light source 11a faces in a direction at a predetermined angle φ1 with the normal to the surface of the photomask 20a on the photomask stage 14. Illumination light (EUV light) from the exposure light source 11a is incident on the inspection mask 20a on the photomask stage 14 at a predetermined angle φ1 with the normal to surface of the mask 20a. Illumination light is then reflected by the inspection mask 20a through the projection optical system 15 to the wafer W on the wafer stage 16.

The aperture Ap2 includes a light shield portion Ap21 and a light transmission hole Ap22. The light shield portion Ap21 shields illumination light from the exposure light source 11a. The hole Ap22 is provided through the light shield portion Ap11. The hole Ap22 may transmit illumination light. The light transmission hole Ap22 is formed on the aperture Ap2 to have a predetermined position shift from the optical axis H when the aperture Ap2 is mounted on the aperture stage 12. Illumination light passing through the light transmission hole Ap22 on the aperture Ap2 provides inspection light at a predetermined angle φ2 with the optical axis H. Inspection light is reflected by the inspection mask 20a through the projection optical system 15 to the wafer W on the wafer stage 16. Note that the predetermined angle φ2 is an angle that allows the inspection mask 20a to diffract the inspection light, thus providing diffraction light as in the first embodiment. The aperture Ap2 is adapted to generate the inspection light at a predetermined angle φ2 with the optical axis H.

The exposure system 10a of the above configuration in the second embodiment has similar effects to those of the exposure system 10 in the first embodiment.

Thus, although the invention has been described with respect to particular embodiments thereof, it is not limited to those embodiments. It will be understood that various modifications, additions, substitutions and the like may be made without departing from the spirit of the present invention. For example, in the above embodiments, the inspection masks 20 and 20a each have the first to fourth patterns 221 to 224. Alternatively, the masks 20 and 20a may have only the first and second patterns 221 and 222. Additionally, the masks 20 and 20a may have more than four patterns.

In the above embodiments, the exposure systems 10 and 10a include the apertures Ap1 and Ap2, respectively. Alternatively, the systems 10 and 10a may each include any element (such as an inspection light illumination portion) that irradiates the inspection masks 20 and 20a with inspection light at the predetermined angle θ with the optical axis H of the illumination light. For example, the apertures Ap1 and Ap2 may be replaced with additional light sources at the predetermined angles θ and φ2, respectively, with the optical axis H of the illumination light.

In the above embodiments, the inspection masks 20 and 20a are mounted on the photomask stage 14. Alternatively, the inspection masks 20 and 20a may be provided in advance on the photomask stage 14.

In the above embodiments, an inspection mask having a combination of different pitch patterns or different direction patterns may be disposed on the photomask stage 14 to measure aberrations.

Processes for emitting inspection light to the inspection mask 20 in the above embodiments may also include the following steps. The second and fourth patterns 222 and 224 (the inner patterns on the inspection mask 20) are illuminated with oblique incident light (inspection light) at the predetermined angle θ with the optical axis H (a first irradiation step). The photomask stage 14 (the inspection mask 20) is then rotated by 180° around the optical axis (a rotational step). The first and third patterns 221 and 223 (the outer patterns on the inspection mask 20) are then illuminated with oblique incident light (inspection light) at the predetermined angle θ with the optical axis H (a second irradiation step). Note that before the second and fourth patterns 222 and 224, the first and third patterns 221 and 223 may be illuminated with inspection light. The relative distance δx may thus be larger than those in the first and second embodiments. This may, therefore, provide a higher resolution of the focus patterns.

In other words, in the above configuration, the aperture Ap1 and the illumination optical system 13a (inspection light illumination portion) use illumination light from the exposure light source 11 to illuminate the second and fourth patterns 222 and 224 with oblique incident light (inspection light) at the predetermined angle θ with the optical axis H. The drive mechanism 17 then allows the photomask stage 14 to rotate the inspection mask 20 by 180° around the optical axis H. The aperture Ap1 and the illumination optical system 13a (inspection light illumination portion) then use illumination light from the exposure light source 11 to illuminate the first and third patterns 221 and 223 with oblique incident light (inspection light) at the predetermined angle θ with the optical axis H. Note that the aperture Ap1 and the illumination optical system 13a (inspection light illumination portion) may illuminate the first and third patterns 221 and 223 with inspection light before the second and fourth patterns 222 and 224.

In the above embodiments, the illumination optical system 13 and the projection optical system 15 are dioptric systems. Alternatively, the optical systems 13 and 15 may be catoptric systems depending on the arrangements of the exposure light sources 11 and 11a or the like.

What is claimed is:

1. A method of inspecting an exposure system, the exposure system using a mask pattern comprising a first mask pattern and a second mask pattern, the first mask pattern being formed in a stripe having a line-and-space of a first pitch, the second mask pattern being disposed in parallel with the first mask pattern and formed in a stripe having a line-and-space of a second pitch different from the first pitch, the exposure system comprising a projection optical system for projecting illumination light to a substrate from a light source,
the method comprising:
illuminating the mask pattern with inspection light at a first angle with the optical axis of the illumination light, allowing the first mask pattern to diffract the inspection light to generate first diffraction light, and allowing the second mask pattern to diffract the inspection light to generate second diffraction light;
measuring the relative distance between a first image due to the first mask pattern and a second image due to the second mask pattern, the first and second images being projected on the substrate via the projection optical system; and
inspecting the condition of the projection optical system based on the relative distance,
the first angle being set to allow the first diffraction light to be diffracted asymmetrically with respect to the optical axis into the projection optical system and the second diffraction light to be diffracted symmetrically with respect to the optical axis into the projection optical system.

2. The method of inspecting an exposure system according to claim 1, wherein
the first diffraction light comprises +1st-order diffraction light of the inspection light, the +1st-order diffraction light being in parallel with the optical axis.

3. The method of inspecting an exposure system according to claim 1, wherein
the mask pattern further comprises a third mask pattern and a fourth mask pattern that are mirror symmetric to the first mask pattern and the second mask pattern with respect to a direction of pitches.

4. The method of inspecting an exposure system according to claim 1, wherein
the first pitch is twice the second pitch.

5. The method of inspecting an exposure system according to claim 1, further comprising:
illuminating the first mask pattern with the inspection light;
rotating, after illuminating the first pattern, the mask pattern by 180° around the optical axis; and
illuminating, after rotating the mask pattern, the second mask pattern with the inspection light.

6. The method of inspecting an exposure system according to claim 1, wherein
the first mask pattern and the second mask pattern are adapted to transmit or reflect the inspection light.

7. The method of inspecting an exposure system according to claim 1, wherein
the projection optical system is adapted to transmit or reflect the first diffraction light and the second diffraction light.

8. The method of inspecting an exposure system according to claim 1, wherein
the illumination light is EUV light.

9. An exposure system comprising:
a mask stage for supporting a mask pattern comprising a first mask pattern and a second mask pattern, the first mask pattern being formed in a stripe having a line-and-space of a first pitch, the second mask pattern being disposed in parallel with the first mask pattern and formed in a stripe having a line-and-space of a second pitch different from the first pitch;
a light source for illuminating the mask stage with illumination light used for exposure of a substrate;
an inspection light illumination portion for illuminating the mask pattern with inspection light at a first angle with the optical axis of the illumination light; and
a projection optical system for projecting the illumination light to the substrate,
the first angle being set to allow the first diffraction light diffracted by the first mask pattern to be diffracted asymmetrically with respect to the optical axis into the projection optical system and the second diffraction light diffracted by the second mask pattern to be diffracted symmetrically with respect to the optical axis into the projection optical system.

10. The exposure system according to claim 9, wherein
the first diffraction light comprises +1st-order diffraction light of the inspection light, the +1st-order diffraction light being in parallel with the optical axis.

11. The exposure system according to claim 9, wherein
the mask pattern further comprises a third mask pattern and a fourth mask pattern that are mirror symmetric to the first mask pattern and the second mask pattern with respect to a direction of the pitches.

12. The exposure system according to claim 9, wherein
the first pitch is twice the second pitch.

13. The exposure system according to claim 9, wherein
the inspection light illumination portion illuminates the first mask pattern with the inspection light,
the mask stage rotates, after the illumination of the first mask pattern with the inspection light, the mask pattern by 180° around the optical axis,
the inspection light illumination portion illuminates, after the rotation of the mask pattern by 180° around the optical axis, the second mask pattern with the inspection light.

14. The exposure system according to claim 9, wherein
the first mask pattern and the second mask pattern are adapted to transmit or reflect the inspection light.

15. The exposure system according to claim 9, wherein
the projection optical system is adapted to transmit or reflect the first diffraction light and the second diffraction light.

16. The exposure system according to claim 9, wherein
the illumination light is EUV light.
